(19) United States
(12) Patent Application Publication
(10) Pub. No.: US 2004/0184425 A1
(43) Pub. Date: Sep. 23, 2004

(54) Method for accessing data from a company over the internet by cellular phone

(75) Inventors: Cheng-Shing Lai, Taipei Hsien (TW); Jia-Sheng Mei, Nanking (CN); Xiao-Long Fan, Nanking (CN)

Correspondence Address: BACON & THOMAS, PLLC, 625 SLATERS LANE, FOURTH FLOOR, ALEXANDRIA, VA, 22314

(73) Assignee: Inventec Appliances Corp., Taipei Hsinen (TW)

(21) Appl. No.: 10/388,646

(22) Filed: Mar. 17, 2003

(51) Int. Cl. H04Q 7/24

(52) U.S. Cl. 370/338

(57) ABSTRACT

The present invention is to provide a method for accessing data from a company over the Internet by a cellular phone comprising the steps of establishing a VPN server in an Intranet within a company and a general connection between the cellular phone and the VPN server, enabling the cellular phone and the VPN server to utilize authorized data transmitted through the general connection to establish a secure tunneling therebetween, commanding the VPN server to issue an IP address of the Intranet to the cellular phone, enabling the cellular phone to directly access data from the VPN server or the Intranet through the IP address.

### FIELD OF THE INVENTION

The present invention relates to the Internet and more particularly to a method for accessing data from a company over the Internet by cellular phone.

### BACKGROUND OF THE INVENTION

Information technology has known a rapid, spectacular development in the past several decades. Also, e-business has gained an increasing popularity recently. The booming of e-business breaks a single role of the information technology in a “New Economy.” Hence, the Information technology not only deals with automation or computerization as viewed by an “Old Economy” but also penetrates into other trades, thus changing the traditional business and management models and lifting a boundary between the “Old Economy” and the “New Economy”. In this regard, there is no doubt that e-business will become a trend for business and management of company in the near future despite of many bubble network companies and worry of the collapse of the “New Economy” recently.

The Internet is booming in this decade. It almost penetrates into all trades and even our daily life. An Intranet within a company can be connected to the Internet. Moreover, an Extranet can be established among all associated factories and affiliated companies. All of the above are infrastructure for a company involving e-business, information computerization, and information exchange among departments within the company, between subsidiaries, and with other organizations.

The so-called “private network” is a network for connecting computers at different locations (i.e., nodes). In the past, an ISDN (Integrated Services Digital Network), dedicated line, or technique of dialing to a host by telephone is employed to connect departments of the company and subsidiaries all over the world together. However, each of the above is disadvantageous for being expensive and inconvenience for maintenance and future expansion. Recently, the Internet is used to establish a private network within a company due to popularity and low communication cost of the Internet. It has the benefit of reducing business cost. Unfortunately, a lack of security for data transmitting over the Internet has limited its applications. For example, a company orders merchandise worth of ten million US dollars to another company over the Internet, a disaster may occur if a third unauthorized party manipulates it as one hundred million US dollars over the Internet.

Fortunately, there is a solution to the problem. The solution is VPN (Virtual Private Network, hereinafter referred to as VPN). The VPN is based on the Internet for meeting the needs of interconnecting the Intranet, the Extranet, and Remote Access. However, the VPN is not implemented by a single technique or product, instead it is a network application. As to the meaning of the VPN, it comprises at least three levels of technology. First, it means V (virtual) involving a technology of establishing a virtual tunneling. Second, it means P (private) involving a technology of tunneling protection. Third, it means N (network) involving a technology of managing many computers connected to the Internet.

The availability of the VPN provides a secure verification for data transfer over the Internet. It functions as a private network having two gates connected to the Internet. Thus, only authorized persons (i.e., ones who know password) can access data from a company at a remote site (i.e., remoter access). As a result, a potential invasion by a hacker is eliminated. Also, such network can expand a typical office to many remote sites. That is, resources can be shared by a head office and its subsidiaries over the Internet. Also, customers, associated factories, etc. are coupled together over the Internet. Hence, several thousands of sales persons not in a company can access data from the company over the Internet by utilizing the VPN. As a result, all company employees can process the company's business by accessing the Internet without worrying of revealing it to an unauthorized person.

In view of the above, the VPN can bring many benefits to a company. In another aspect, consumers have an increasing demand to quality of electronic products such as cellular phones. For applying a cellular phone to wider applications, global cellular phone manufacturers continuously develop cellular phones being more convenient, more powerful, and more user friendly. It is understood that a cellular phone is advantageous for being portable and compact. Hence, a popularity of the cellular phone is high throughout the world. However, such popular communication tool does not provide a means for any employee of a company to access data from the company by using it. Hence, many precious business opportunities are lost.

Thus, it is desirable among organizations to provide a novel method capable of overcoming the above drawbacks of the prior art.

### SUMMARY OF THE INVENTION

A primary object of the present invention is to provide a method for accessing data from a company over the Internet by a cellular phone comprising establishing a VPN server in an Intranet within a company, establishing a general connection between the cellular phone and the VPN server, enabling the cellular phone and the VPN server to utilize authorized data transmitted through the general connection to establish a secure VPN tunneling between the cellular phone and the VPN server, enabling the VPN server to issue an IP address of the Intranet to the cellular phone, and enabling the cellular phone to directly access data from the VPN server or share information from the Intranet through the IP address and common file systems provided in the cellular phone and the VPN server. By utilizing this method, a dedicated line connected to the Internet is established by utilizing the VPN so as to meeting the needs of interconnecting the Intranet, the Extranet, and Remote Access. Most importantly, the present invention can overcome the above drawbacks of the prior art. For example, a great popularity of the cellular phone among us does not provide a means for any employee of a company to access data from the company by using it. Many precious business opportunities are lost undesirably.

The above and other objects, features and advantages of the present invention will become apparent from the following detailed description taken with the accompanying drawings.

### BRIEF DESCRIPTION OF THE DRAWINGS

FIG. 1 presents schematically a structure applicable for a preferred embodiment of the invention; and

FIG. 2 is a flow chart illustrating a process according to the invention.

### DETAILED DESCRIPTION OF THE PREFERRED EMBODIMENTS

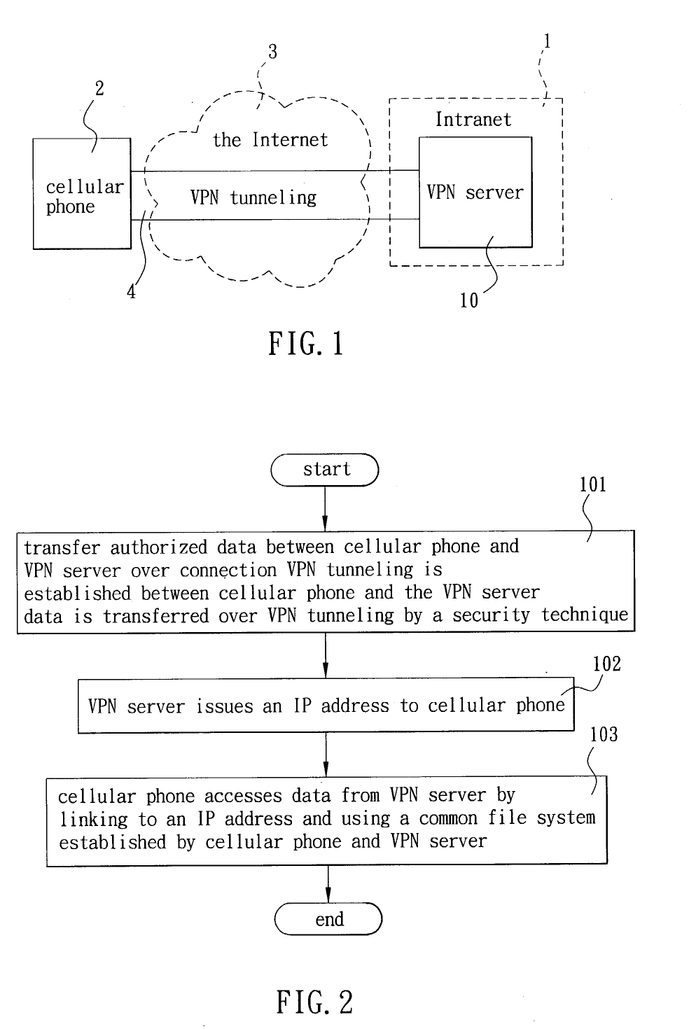

The invention is directed to a method for accessing data from a company over the Internet by cellular phone, as referring to FIG. 1. The method is effected in a system, which comprises a general connection between a cellular phone 2 and a VPN server 10 provided in an Intranet 1 within a company. The general connection is established by using a PPP (Point to Point Protocol) to connect to the Internet 3, enabling authorized data to be transmitted between the cellular phone 2 and the VPN server 10 over the general connection and establishing a VPN tunneling 4 between the cellular phone 2 and the VPN server 10 in accordance the authorized data. The VPN tunneling 4 similar to LAN (local area network) is established between the cellular phone 2 and the VPN server 10. As a result, data can be transmitted through the VPN tunneling 4 by a security technique. After the VPN server 10 issues an IP (Internet protocol) address to the cellular phone 2, the cellular phone 2 can then access data from the VPN server 10 by utilizing the IP address and a common file system provided in the cellular phone 2 and the VPN server 10.

In the invention as shown in FIG. 1, the authorized data, such as an IP address pointed to the VPN server 10, a set of password for verification, and a user name, has to be set in the cellular phone 2 in advance for connecting the cellular phone 2 to the VPN server 10 and enabling the cellular phone 2 to establish the VPN tunneling 4 from the Intranet 1 according to the authorized data. After a connection between the cellular phone 2 and the VPN server 10 has been established, the VPN server 10 is authorized to verify whether the connection is legal, while being verified, the VPN server 10 is then able to establish the VPN tunneling 4 to the Intranet 1.

Referring to FIG. 2 in conjunction with FIG. 1, there is shown a process about how to establish the VPN tunneling 4 between the cellular phone 2 and the VPN server 10. It comprises the following steps:

In step 101, transfer authorized data between the cellular phone 2 and the VPN server 10 over the general connection. Further, the VPN tunneling 4 similar to the LAN is established between the cellular phone 2 and the VPN server 10. As a result, data can be transferred in the VPN tunneling 4 by a security technique. In step 102, the VPN server 10 issues an IP address to the cellular phone 2. In step 103, the cellular phone 2 can access data from the VPN server 10 through the IP address and the common file system provided in the cellular phone 2 and the VPN server 10.

Referring to FIG. 1 again, in the invention a PPTP (Point to Point Tunneling Protocol) or a P2TP (Layer Two Tunneling Protocol) is used to establish the VPN tunneling 4. However, both are well known in the art. Thus a detailed description thereof is omitted herein for the sake of brevity.

Since the VPN is utilized to send important data over the Internet and prevent those important data from being invading by other competitive or unauthorized parties. Hence, how to secure data transmitting has become the most important consideration of the VPN. A security defined herein not only means confidentiality of data (i.e., avoiding an overhearing by a third unauthorized party) but also ensures there is no manipulation of data during transmitting over the Internet (i.e., maintaining an integrity). Further, it is required to authenticate that data is not manipulated by the third unauthorized party over the Internet. Hence, in the invention the security technique is implemented as an IP Sec (Internet Protocol Security). The IP Sec provides two secure protocols. Namely, an AH (Authentication Header) and an ESP (Encapsulating Security Payload). The AH is served to authenticate a frame source and an integrity of data. Hence, it is possible of detecting a manipulated frame over the Internet. The ESP can integrate other encryption algorithms such as DES (Data Encryption Standard), 3DES, and AES (Authorization Encryption Standard) at the same time. Hence, there is no need to worry that an encrypted frame is manipulated by the third unauthorized party. Also, the ESP has an authentication capability similar to the AH. However, these techniques are well known and are not critical to the invention. Thus a detailed description thereof is omitted herein for the sake of brevity.

In addition, a main purpose of the common file system is to enable a cellular phone 2 user to access data from the Intranet 1 at any time and/or place. Hence, the common file system can be implemented either as a NFS (Network File System) or a NIS (Network Information Services). However, both are well known. Thus a detailed description thereof is omitted herein for the sake of brevity.

While the invention has been described by means of specific embodiments numerous modifications and variations could be made thereto by those skilled in the art without departing from the scope and spirit of the invention set forth in the claims.

What is claimed is:

1. A method for accessing data from a company over the Internet by a cellular phone comprising the steps of:
connecting the cellular phone and a VPN (Virtual Private Network) server provided in an Intranet to the Internet by using a PPP (Point to Point Protocol) for establishing a general connection and a data communication between the cellular phone and the VPN server;
transferring authorized data between the cellular phone and the VPN server over the general connection, establishing a VPN tunneling similar to LAN (local area network) between the cellular phone and the VPN server, and transferring data through the VPN tunneling by a security technique;
commanding the VPN server to issue an IP (Internet protocol) address to the cellular phone; and
enabling the cellular phone to access data from the VPN server through the IP address and a common file system established in the cellular phone and the VPN server.

2. The method of claim 1, wherein the IP address pointed to the VPN server, a set of password for verification and a user name in advance have to be set in the cellular phone in advance in order to enable the cellular phone to connect to the VPN server.

3. The method of claim 1, wherein the cellular phone is authorized to establish the VPN tunneling from the Intranet, after establishing a connection between the cellular phone and the VPN server, the VPN server is authorized to verify, and after a successful verification, the VPN server is capable of establishing the VPN tunneling to the Intranet.

4. The method of claim 1, further comprising a PPTP (Point to Point Tunneling Protocol) for establishing the VPN tunneling between the cellular phone and the Intranet.

5. The method of claim 1, further comprising a P2TP (Layer Two Tunneling Protocol) for establishing the VPN tunneling between the cellular phone and the Intranet.

6. The method of claim 1, wherein the security technique is implemented as an IP Sec (Internet Protocol Security), the IP Sec being capable of providing an AH (Authentication Header) and an ESP (Encapsulating Security Payload).
